(19) United States
(12) Patent Application Publication
(10) Pub. No.: US 2017/0260372 A1
(43) Pub. Date: Sep. 14, 2017

(54) THERMOPLASTIC MOULDING COMPOUNDS

(71) Applicant: LANXESS DEUTSCHLAND GMBH, Cologne (DE)

(72) Inventors: MATTHIAS BIENMUELLER, Krefeld (DE); WOLFGANG WAMBACH, Cologne (DE); JOCHEN ENDTNER, COLOGNE (DE)

(73) Assignee: LANXESS Deutschland GmbH, Cologne (DE)

(21) Appl. No.: 15/605,001

(22) Filed: May 25, 2017

Related U.S. Application Data
(63) Continuation-in-part of application No. 15/062,252, filed on Mar. 7, 2016.

(30) Foreign Application Priority Data
Mar. 9, 2015 (EP) 15158161.8

(51) Int. Cl. C08K 13/02; B29C 45/00; B29C 47/00; B29B 9/06

(52) U.S. Cl. CPC C08K 13/02; B29B 9/06; B29C 45/0001; B29C 47/0004; B29K 2067/00

(57) ABSTRACT

The invention relates to compositions and also to thermoplastic moulding compounds which can be produced from these compositions, and to products based thereon in turn, comprising at least one polyalkylene terephthalate or polycycloalkylene terephthalate, at least one organic phosphinic salt and/or at least one organic diphosphinic salt, a further melamine derivative different from the condensed melamine derivative, at least one condensed melamine derivative and at least one inorganic phosphate salt.

### CROSS REFERENCE TO RELATED APPLICATIONS

This application is a continuation-in-part of pending U.S. application Ser. No. 15/062,252, filed Mar. 7, 2016, with the same title, which claims priority to European Patent Application No. 1515816.8, filed Mar. 9, 2015, entitled Thermoplastic Moulding Matters, all incorporated herein by reference.

### FIELD OF THE INVENTION

The invention relates to compositions and also to thermoplastic moulding compounds which can be produced from these compositions, and to products based thereon in turn, comprising at least one polyalkylene terephthalate or polycycloalkylene terephthalate, at least one organic phosphinic salt and/or at least one organic diphosphinic salt, at least one melamine derivative and at least one inorganic phosphate salt.

### BACKGROUND OF THE INVENTION

Not least because of their good electrical indices, for example with regard to dielectric strength and specific breakdown resistance, polyesters are popular materials in electronic and electrical applications. Because of the risk of fire in the vicinity of current-conducting components, materials that have been rendered flame-retardant are frequently used. According to the field of use, what is being sought is not only is good self-extinction in the form of a UL94 V-0 classification (Underwriters Laboratories Inc. Standard of Safety, “Test for Flammability of Plastic Materials for Parts in Devices and Appliances”, p. 14 to p. 18 Northbrook 1998), but also low ignitability. For example, IEC 60335-1, for components in unattended domestic appliances within a distance of 3 mm from current-conducting components with currents _{>}0.2 A, specifies a glow wire test according to IEC 60695-2-11 on the finished component, where there must be no appearance of flame for more than two seconds at a glow wire temperature of 750° C. Experience shows that test results on a finished component, because of the undefined geometry of finished components or else the metal contacts that impair heat flow, do not correspond directly to test results which have been conducted according to IEC 60695-2-13 on a defined round plaque at the same glow wire temperature, especially since, according to IEC 60695-2-13, a specimen is considered to have “not ignited” even if a flame appears for less than 5 seconds.

In order to ensure that a material in the finished component too, and irrespective of the geometry, does not show a flame with a burn time of longer than 2 seconds even at glow wire temperature 750° C., there is an increasing desire for materials which have a greater safety margin in a plaque test according to IEC 60695-2-13, meaning that there is still no flammability over and above standard requirements, even at distinctly higher glow wire temperatures than 750° C., in which context “no flammability” is not interpreted as meaning, according to IEC 60895-213, appearance of flame for <5 seconds, but as meaning no flame at all in the literal sense, i.e. as a burn time of 0 seconds. In order to take account of the variable thicknesses of the finished components, this should ideally be fulfilled in test plaques having a wall thickness of at least 3 mm, and also in thin test plaques having a maximum wall thickness of 0.75 mm.

An additional factor is that, in recent times, not least for ecological reasons and especially after the fire disaster at Düsseldorf Airport in 1996, there is an increasing demand for halogen-free solutions in respect of flame retardancy. However, it is important that, in the case of use of halogen-free flame retardants, which are by no means rarely nonfusible solids, other properties that are important for use in applications are not neglected. These especially include adequate mechanical performance and very substantial avoidance of thermal degradation of the polymer system through interactions with the halogen-free flame retardant package.

DE 101 96 299 T1 discloses flame-retardant resin compositions based inter alia on polyethylene terephthalate and polybutylene terephthalate (examples 28-30) that use as flame retardant aluminium methylethylphosphinate, in combination with melamine polyphosphate in example 29, and also, additionally, calcium hydrogen phosphate.

DE 11 2006 001 824 T5 describes flame-retardant resin compositions with halogen-containing flame retardants. Example 17 comprises PBT, PET, a bromine-containing flame retardant and calcium hydrogen phosphate as heat stabilizer.

WO 2012/139990 A1 discloses tracking-resistant, flame-retardant, reinforced thermoplastic moulding compounds based on polyalkylene terephthalates and comprising not only a flame retardant composed of nitrogen-containing or phosphorus-containing compounds but also a polyolefin from the group of polyethylene, polypropylene, and polypropylene copolymers. These moulding compounds are indeed notable for increased tracking resistance, albeit at the expense of mechanical properties such as the tensile strength, for example. The use of polyolefins as a polymer for addition harbours the risk, moreover, of inevitable detractions from the advantages typical of polyalkylene terephthalates, such as high surface tension and high colour stability under thermal load. A disadvantage of halogen-containing flame retardants is the possibility in the event of fire of increased formation of highly toxic dioxins and furans.

DE 112007001618 T5 discloses polybutylene terephthalate (PBT)-based compositions based on halogenated flame retardants, where the glow wire ignition temperature GWIT according to IEC 60695-2-13 at wall thickness 0.75 mm was improved up to a value of 825° C. when 1 to 100 parts by mass of a nitrogen compound are added. As well as melamine cyanurate, which is cited by way of example, melem is also cited as an example of nitrogen compounds, but without specifically addressing the effect thereof with respect to glow wire ignitability and mechanical properties in compositions comprising halogen-free flame retardants.

EP 2 927 279 A1 describes compositions comprising PBT, phosphinic salts, >4% by weight of a phosphazene compound and cyclic nitrogen compounds, which attain a glow wire ignition temperature GWIT according to IEC 60695-2-13 on plaques of different thickness of at least 775° C. EP 2 927 279 A1 also mentions melem in the description of the examples of the cyclic nitrogen compounds. However, there are no pointers to GWIT values above 800° C. or means of stabilizing compositions comprising melem to the effect that no significant losses in the mechanical properties have to be accepted.

DE 11 2006 001 824 T5 describes flame-retardant resin compositions with halogen-containing flame retardants. Example 17 comprises polybutylene terephthalate (PBT), polyethylene terephthalate (PET), a brominated flame retardant and calcium dihydrogenphosphate as heat stabilizer.

WO 01/94472 A1 discloses flame-retardant resin compositions based inter alia on polyethylene terephthalate and polybutylene terephthalate (examples 28-30) that use aluminium methylethylphosphinate as flame retardant, in combination with melamine polyphosphate as nitrogen compound in example 29, and additionally calcium hydrogenphosphate, but without specifically addressing glow wire ignition characteristics or mechanical properties.

It was an object of the present invention, therefore, to provide flame-retardant polyalkylene terephthalate- or polycycloalkylene terephthalate based thermoplastic moulding compounds having increased tracking resistance and preferably without halogen-containing flame retardants, these moulding compounds dispensing with the use of polyolefins and allowing the production therefrom of products which, by comparison with moulding compounds without enhanced tracking resistance, exhibit no loss in the mechanical properties, especially the strength, and which also exhibit no deterioration in fire performance.

For the reasons mentioned above, the use of halogenated flame retardants is unwanted, and the problem addressed by the present invention was that of dispensing with the use of halogenated flame retardants and nevertheless providing flame-retardant compositions and moulding compounds or products producible therefrom that are based on at least one polyalkylene terephthalate and/or polycycloalkylene terephthalate, which, at wall thicknesses of ≧0.75 mm in the glow wire test according to IEC 60695-2-13, do not show any ignition even at glow wire temperatures of ≧800° C. and where the additization with corresponding flame retardants does not have any significant effects on the mechanical properties. Furthermore, the additization should lead to a minimum level of thermal degradation of the polyalkylene terephthalate and/or polycycloalkylene terephthalate used as the polymer.

### SUMMARY OF THE INVENTION

The achievement of the object and subject of the invention are compositions, and also thermoplastic moulding compounds and products which can be produced from them, comprising
A) at least one polyalkylene terephthalate or polycycloalkylene terephthalate,
B) at least one organic phosphinic salt of the formula (I) and/or at least one organic diphosphinic salt of the formula (II) and/or polymers thereof,

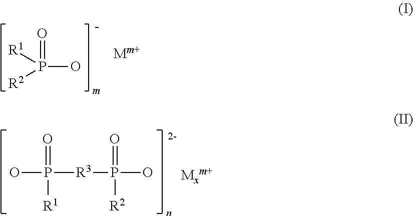

wherein
R¹ and R² are identical or different and are a linear or branched C₁-C₆ alkyl, and/or are C₆-C₁₄ aryl,
R³ is linear or branched C₁-C₁₀ alkylene, C₆-C₁₀ arylene or C₁-C₆ alkyl-C₆-C₁₀ arylene or C₆-C₁₀ aryl-C₁-C₆ alkylene,
M is aluminium, zinc or titanium,
m is an integer in the range from 1 to 4;
n is an integer in the range from 1 to 3, and
x is 1 and 2,
and n, x and min formula (II) may at the same time adopt only those integers such that the diphosphinic salt of the formula (II) as a whole is uncharged, and
C) at least one inorganic phosphate salt from the group of metal hydrogen phosphates, metal dihydrogen phosphates, metal dihydrogen pyrophosphates and/or metal pyrophosphates, metal being sodium, potassium, magnesium, zinc, copper and/or aluminium.

Products based on the compositions of the invention surprisingly exhibit, even without the use of polyolefins, a tracking resistance which is at least at an equivalent level to that in the prior art, but exhibit no loss hi terms of the mechanical parameters of flexural strength, outer fibre strain or IZOD impact strength,

Explanations/Definitions

For clarification, it should be noted that, in the context of this invention, all definitions and parameters set out below, either general or stated within ranges of preference, are encompassed in any desired combinations.

Moreover, for clarification, it should be noted that the flexural strength in technical mechanics is a value for a flexural strain in a component subject to flexure, which if exceeded is accompanied by fracture failure of the component. It describes the resistance that a workpiece offers to flexing or fracture thereof. In the ISO 178 accelerated flexural test, specimens in beam form, presently with dimensions of 80 mm·10 mm·4.0 mm at the ends, are placed on two supports and loaded in the centre with a flexural die (Bodo Carlowitz: Tabellarische Übersicht über die Prüfung von Kunststoffen, 6th Edition, Giesel-Verlag für Publizität, 1992, pp, 16-17).

According to “http://de.wikipedia.org/wiki/Biegeversuch”, the flexural modulus is determined in the three-point bending test, with a test specimen being positioned on two supports and loaded in the centre with a test die. For a flat sample, the flexural modulus is then calculated according to formula (III) as follows:

E=Iᵥ³(X_{H}−X_{L})/4 D_{L}ba³ (III)

where E=flexural modulus in kN/mm²; Iᵥ=span in mm; X_{H}=end of determination of flexural modulus in kN; X_{L}=beginning of determination of flexural modulus in kN; D_{L}=flexing in mm between and X_{H} and X_{L}; b=sample width in mm; a=sample thickness in mm.

The impact resistance describes the capacity of a material to absorb impact energy and collision energy without undergoing fracture. Impact resistance is calculated as the ratio of impact energy and specimen cross section (unit of measurement: kJ/m²).

Impact resistance can be determined by various kinds of notched impact flexural test (Charpy, Izod). In contrast to the notched impact resistance, there is no notching carried out in the case of the impact resistance of the test specimens. In the context of the present invention, the Izod impact resistance was determined in accordance with ISO 180-1U on freshly injection moulded test specimens with dimensions of 80 mm·10 mm·4 mm.

The tracking resistance characterizes the dielectric strength of the surface (track path) of insulating materials, especially on exposure to moisture and contaminants. It defines the maximum tracking current which can be brought about under standardized testing conditions (specified voltage, conductive layer material) in a defined test arrangement (electrode spacing, electrode form). The tracking resistance is reported using the CTI (Comparative Tracking Index). The CTI is the voltage up to which the base material exhibits no tracking on dropwise application of 50 drops of standardized electrolyte solutions (A or B giving KA or KB values). Measurement is carried out on the surface, with one drop falling between two platinum electrodes every 30 seconds. The criterion of failure is a tracking current of >0.5 A. Details on the measurement method for the CTI are stipulated in IEC 60112.

The melt volume-flow rate (MVR, formerly and often even now in the jargon Melt Volume Rate or MVI for Melt Volume Index) is used to characterize the flow behaviour (moulding composition testing) of a thermoplastic under defined pressure and temperature conditions. The melt mass-flow rate is determined as for the melt volume-flow rate, and the result of the measurement is different by the melt density. The MVR is a measure of the viscosity of a polymeric melt. From the MVA it is possible to conclude the degree of polymerization, this being the average number of monomer units in one molecule.

The MVR is determined according to ISO 1133, in the context of the present invention, by means of a capillary rheometer, with the material (pellets or powder) being melted in a heatable cylinder and pressed, under a pressure resulting from the applied load, through a defined nozzle (capillary). A determination is made of the emerging volume or mass, respectively, of the polymer melt (referred to as the axtrudate) as a function of time. A key advantage of the melt volume-flow rate lies in the simplicity of measuring the piston travel for a known piston diameter in order to determine the volume of melt that has emerged. The relevant equation is as follows: MVR=volume/10 min. The unit for MVR is cm³/10 min.

No ignition in the glow wire test shall be understood to mean that there is no flame, i.e. the burn time of the flame is 0 seconds.

No significant effects on the mechanical properties shall be understood in accordance with the invention such that the mechanical level does not drop significantly below the level of compositions without corresponding flammability-inhibiting additives as a result of use of flammability-inhibiting additives, the mechanical level being assessed with reference to flexural strength based on ISO 178 and IZOD impact resistance based on ISO 180-1U. A measure used for the thermal degradation of the polymer used (”chain degradation“) is the MVR according to ISO 1133.

“Alkyl” in the context of the present invention identifies a straight-chain or branched, saturated hydrocarbon group. In certain embodiments, an alkyl group having 1 to 6 carbon atoms is used. It can then be referred to as a “lower alkyl group”. Preferred alkyl groups are methyl (Me), ethyl (Et), propyl, more particularly n-propyl and isopropyl, butyl, more particularly n-butyl, isobutyl, sac-butyl, tert-butyl, pentyl groups, more particularly n-pentyl, isopentyl, neopentyl, hexyl groups and the like. Similar comments apply in respect of the term “polyalkylene”.

“Aryl” in the context of the present invention denotes a monocyclic aromatic hydrocarbon ring system or a polycyclic ring system in which two or more aromatic hydrocarbon rings are fused, or at least one aromatic monocyclic hydrocarbon ring which is fused with one or more cycloalkyl and/or cycloheteroalkyl rings. In embodiments according to the invention, aryl or arylene is an aryl group having 6 to 14 carbon atoms. Preferred aryl groups having an aromatic carbocyclic ring system are phenyl, 1-naphthyl (bicyclic), 2-naphthyl (bicyclic), anthracenyl (tricyclic), phenanthrenyl (tricyclic), pentacenyl (pentacyclic) and similar groups. Other preferred aryl groups are benzodioxanyl, benzodioxolyl, chromanyl, indolinyl groups and the like. In certain embodiments, aryl groups, as described herein, may be substituted. In certain embodiments, an aryl group may have one or more substituents.

“Alkylaryl” in the sense of the present invention denotes an alkyl-aryl group, the alkylaryl group being bonded covalently through the alkyl group to the defined chemical structure. One alkylaryl group preferred in accordance with the invention is the benzyl group (—CH₂—C₆H₅). Alkylaryl groups according to the present invention may alternatively be substituted, meaning that either the aryl group and/or the alkyl group may be substituted. In contrast to this, “arylalkyl” in the sense of the present invention denotes an aryl-alkyl group where the arylalkyl group is bonded covalently through the aryl group to the defined chemical structure.

With regard to the d50 and d97 values in this application, the determination thereof and the meaning thereof, reference is also made to Chemie Ingenieur Technik (72) p. 273-276, 3/2000, Wiley-VCH Verlags GmbH, Weinheim, 2000, according to which the d50 is that particle size below which 50% of the amount of particles lie (median value) and the d97 is that particle size below which 97% of the amount of particles lie.

Figures for particle size distribution or for particle sizes in the context of the present invention refer to what are called surface-based particle sizes, in each case prior to incorporation into the moulding compound. The particle size is determined in the context of the present invention by laser diffractometry; see C. M. Keck, Modeme Pharmazeutische Technologie [Modern Pharmaceutical Technology] 2009, Free University of Benin, Chapter 3.1. or QUANTACHROME PARTIKELWELT NO 6, June 2007, pages 1 to 16. The underlying standard is ISO 13317-3.

The standards cited in this specification are applicated in their version at the filing date of the present patent application.

### DESCRIPTION OF THE EMBODIMENTS

The solution to the problem and the subject-matter of the invention are compositions, moulding compounds and products comprising

A) at least one polyalkylene terephthalate or polycycloalkylene terephthalate,

B) at least one organic phosphinic salt of the formula (I) and/or at least one organic diphosphinic salt of the formula (II) and/or polymers thereof,

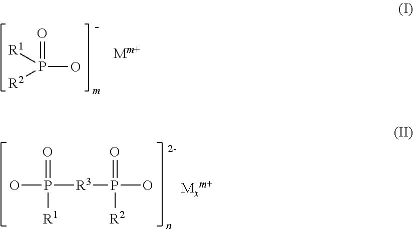

wherein

R¹, R² are the same or different and are each a linear or branched C₁-C₆-alkyl, and/or C₆-C₁₄-aryl,

A³ is linear or branched C₁-C₁₀ alkylene, C₆-C₁₀ arylene or C₁-C₆ alkyl-C₆-C₁₀ arylene or C₆-C₁₀ aryl-C₁-C₆ alkylene,

M is aluminium, zinc or titanium,

m is an integer in the range from 1 to 4

n is an integer in the range from 1 to 3, and

x is 1 or 2,

where n, x and m in formula (II) may at the same time adopt only such integer values that the diphosphinic salt of the formula (II) as a whole is uncharged,

C) at least one inorganic phosphate salt from the group of aluminium tris(dihydrogenphosphate), magnesium bis(dihydrogenphosphate), zinc bis(dihydragenphosphate) and zinc bis(dihydrogenphosphate) dihydrate, preferably magnesium bis(dihydrogenphosphate) or zinc bis(dihydrogenphosphate) dihydrate, especially magnesium bis(dihydrogenphosphate).

D) at least one condensed melamine derivative, and

E) at least one melamine derivative other than component D).

Surprisingly, products based on the halogen-free compositions according to the invention, compared to the prior art, have very high glow wire ignitability values without exhibiting disadvantages in the mechanical properties and without having higher chain degradation in the polymer (component A)). In the case of use of a combination of component C), component D) and component E), it is thus possible in polyesters of component A) that have been rendered flame-retardant by component B) to achieve both high GWIT values and simultaneously high thermal stability, demonstrated by high values for flexural resistance and impact resistance, in a halogen free manner. In the course of the invention it was found that if at least one of the two components C) and/or D) is absent, there is either a drop in the mechanical indices or else a reduction in flame retardancy, which is demonstrated by corresponding experiments in the Examples section.

More preferred, the invention relates to compositions, moulding compounds and products comprising, based on 100 parts by mass of component A),

10 to 70 parts by mass of component B), preferably 25 to 35 parts by mass,

1 to 30 parts by mass of component C), preferably 10 to 15 party by mass,

0.01 to 5 parts by mass of component D), preferably 0.5 to 1 part by mass, and

2 to 50 parts by mass of component E), preferably 10 to 20 parts by mass.

In one embodiment, the compositions, moulding compounds and products according to the invention comprise, in addition to components A) to E), also F) at least one metal sulphate, preferably in amounts of 1 to 40 parts by mass, based on 100 parts by mass of component A), preferably 1 to 10 parts by mass.

In one embodiment, the compositions, moulding compounds and products according to the invention comprise, in addition to components A) to F), or in place of F), also G) at least one filler or reinforcer other than components B) to F), preferably in amounts of 0.1 to 300 parts by mass, based on 100 parts by mass of component A), preferably 50 to 100 parts by mass.

In one embodiment, the compositions, moulding compounds and products according to the invention comprise, in addition to components A) to G) or in place of F) and/or G), also H) at least one further additive other than components B) to G), preferably in amounts of 0.01 to 80 parts by mass, based on 100 parts by mass of component A), preferably 1 to 10 parts by mass.

According to the invention, components F), G) and H) may be present in the compositions, moulding compounds and products, but they may also be absent, so that the following combinations of the components may arise for the compositions, moulding compounds and products; A), B), C), D), E);

A), B), C), D), E), F); A), B), C), D), E), G); A), B), C), D), E), H);

A), B), C), D), E), F), G); A), B), C), D), E), F), H); A), B), C), D), E), F), H);

A), B), C), D), E), F), G), H),

The compositions according to the invention, also generally referred to in the plastics industry as moulding compounds, are obtained on processing of components A) to E) and optionally also at least one of components F), G) or H), preferably as pelletized material, in the form of extrudates or as powder. Formulation is effected by mixing the compositions according to the invention in at least one mixing apparatus, preferably a compounder, particularly preferably a corotating twin-screw extruder. The procedure of mixing of components A) to E) and optionally at least one further component F) and/or G) and/or H) to produce compositions according to the invention in the form of powders, pelletized materials or extruclates is also referred to in the plastics industry as compounding. This affords, as intermediates, moulding compounds based on the compositions according to the invention. These moulding compounds—also known as thermoplastic moulding compounds—may either be composed exclusively of components A) to E) or else may comprise, in addition to components A) to E), further components, preferably at least one of components F) and/or G) and/or H). In a further step, the moulding compounds of the invention are then subjected as matrix material to an injection moulding or extrusion operation, preferably an injection moulding operation, in order to produce products according to the invention therefrom. Products according to the invention therefore comprise the same components A) to E) and optionally additionally at least one of components F), G) or H).

Component A)

The polyalkylene terephthalates or polycycloalkylene terephthalates for use as component A) in accordance with the invention may be prepared by various methods, may be synthesized from a variety of building blocks, and, in a specific application scenario, may be equipped, alone or in combination, with processing aids, stabilizers, polymeric alloying co-components (e.g. elastomers) or else reinforcing materials (such as mineral fillers or glass fibres, for example) and optionally further additives, to give materials having tailored combinations of properties.

Also suitable are blends with fractions of other polymers, in which case it is possible optionally for one or more compatibilizers to be employed. The properties of the polymers may be improved as and when needed by addition of elastomers.

Preferred polyalkylene terephthalates or polycycloalkylene terephthalates can be prepared from terephthalic add (or reactive derivatives thereof) and aliphatic or cycloaliphatic diols having 2 to 10 C atoms by known methods (Kunststoff-Handbuch, vol. VIII, pp. 695 ff, Karl Hanser Verlag, Munich 1973).

Preferred polyalkylene terephthalates or polycycloalkylene terephthalates comprise at least 80 mol %, preferably at least 90 mol %, based on the dicarboxylic acid, of terephthalic acid radicals and at least 80 mol %, preferably at least 90 mol %, based on the dial component, of 1,4-cyclohexanedimethanal and/or ethylene glycol and/or propane-1,3-diol (in the case of polypropylene terephthalate) and/or butane-1,4-diol radicals.

Preferred polyalkylene terephthalates or polycycloalkylene terephthalates may as well as terephthalic acid radicals include up to 20 mol % of radicals of other aromatic dicarboxylic acids having 8 to 14 C atoms or radicals of aliphatic dicarboxylic adds having 4 to 12 C atoms, more particularly radicals of phthalic acid, isophthalic acid, naphthalene-2,6-dicarboxylic acid, 4,4′-biphenyldicarboxylic acid, succinic acid, adipic acid, sebacic acid, azelaic acid, cyclohexanediacetic acid, cyclohexanedicarboxylic acid,

Preferred polyalkylene terephthalates or polycycloalkylene terephthalates may as well as 1,4-cyclohexanedimethanol and/or ethylene glycol and/or 1,3-propanediol and/or 1,4-butanediol include up to 20 mol % of other aliphatic dials having 3 to 12 C atoms or up to 20 mol % of cycloaliphatic dials having 6 to 21 C atoms, preferably radicals of prapane-1,3-diol, 2-ethylpropane-1,3-diol, neopenlyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-dial, 2,2-diethylpropane-1,3-diol, hexane-2,5-diol, 1,4-di(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxypropoxyphenyl)propane.

Particularly preferred are polyalkylene terephthalates or polycycloalkylene terephthalates prepared solely from terephthalic acid and reactive derivatives thereof, especially dialkyl esters thereof, and 1,4-cyclohexanedimethanol and/or ethylene glycol and/or 1,3-propanediol and/or 1,4-batanediol, especially preferably poly-1,4-cyclohexanedimethanol terephthalate, polyethylene terephthalate and polybutylene terephthalate and mixtures thereof.

Preferred polyalkylene terephthalates or polycycloalkylene terephthalates are also copolyesters prepared from at least two of the abovementioned add components and/or from at least two of the abovementioned alcohol components. Particularly preferred copolyesters are polyethylene glycol/butane-1,4-diol) terephthalates.

The polyalkylene terephthalates or polycycloalkylene terephthalates generally possess an intrinsic viscosity in the range from 30 to 150 cm³/g, preferably in the range from 40 to 130 cm³/g, more preferably in the range from 50 to 100 cm^{c}/g, measured in each case in phenol/o-dichlorobenzene (1:1 part by weight) at 25° C. The intrinsic viscosity IV, also referred to as Staudinger Index or limiting viscosity, is proportional, according to the Mark-Houwink equation, to the average molecular mass, and is the extrapolation of the viscosity number VN for the case of vanishing polymer concentrations. It can be estimated from measurement series or through the use of suitable approximation methods (e.g. Billmeyer). The VN [ml/g] is obtained from the measurement of the solution viscosity in a capillary viscometer, an Ubbelohde viscometer, for example. The solution viscosity is a measure of the average molecular weight of a polymer. Determination is made on dissolved polymer, with various solvents (formic acid, m-cresol, tetrachloroethane, phenol, 1,2-dichlorobenzene, etc.) and concentrations being used. Through the viscosity number VN it is possible to monitor the processing and service properties of polymers. A thermal load on the polymer, ageing processes or exposure to chemicals, weathering and light can be investigated by means of comparative measurements. The process is standardized for common polymers: in the context of the present invention, according to DIN ISO 1628-5 for polyesters. In this regard, see also: http://de.wikipedia.org/wiki/Viskosimetrie and “http://de.wikipedia.org/wiki/Mark-Houwink-Gleichung”.

The polyalkylene terephthalates or polycycloalkylene terephthalates for use as component A) in accordance with the invention may also be used in a mixture with other polyesters and/or further polymers.

Customary additives, especially mould release agents, may be admixed ire the melt, during compounding, to the polyalkylene terephthalates or polycycloalkylene terephthalates to be used as component A).

The skilled person understands compounding (Compound=mixture) as a term from plastics technology which can be equated with plastics processing and which describes the upgrading process of plastics by admixing of adjuvants (fillers, additives and so on) for targeted optimization of the profiles of properties. Compounding takes place preferably in extruders, more preferably in co-rotating twin-screw extruders, counter-rotating twin-screw extruders, planetary roller extruders or co-kneaders, and encompasses the process operations of conveying, melting, dispersing, mixing, degassing and pressure build-up.

The polyethylene terephthalate for use as component A) may also be recyclate. Recyclates are generally understood to mean:
1) what is called post-industrial recyclate (also called pre-consumer recyclate): this comprises production wastes from polycondensation, from compounding (e.g. off-spec material) or from processing, for example sprues in injection moulding, start-up material in processing by injection moulding or extrusion, or edges cut from extruded sheets or films.
2) post-consumer recyclate: this comprises plastics articles which are collected and processed after use by the end user. By far the dominant articles in terms of quantity are blow-moulded PET bottles for mineral water, soft drinks and juices.

PET recyclates from PET bottles to be recycled which are used with preference in accordance with the invention as component A) are preferably obtained by a process according to DE 103 24 098 A1, WO 2004/009315 A1 or according to WO 2007/116022 A2,

Used preferably as component A) is at least one polyalkylene terephthalate to be selected from polyethylene terephthalate [CAS No. 25038-59-9] or polybutylene terephthalate [CAS No. 24988-12-5], especially polybutylene terephthalate (PBT).

An alternative used as component A) is preferably poly-1,4-cyclohexanedimethanol terephthalate [CAS No. 25037-994] as polycycloalkylene terephthalate.

Component B)

The organic phosphinic salts for use in accordance with the invention as component B), of the formula (I) indicated above, and/or organic diphosphinic salts of the formula (II) indicated above and/or polymers thereof are also referred to in the context of the present invention as phosphinates.

In the formulae (I) or (II), M is preferably aluminium. In the formulae (I) and (III), R¹ and R² are preferably identical or different and are C₁-C₆ alkyl, linear or branched, and/or phenyl. More preferably, R¹ and R² are identical or different and are methyl, ethyl, n-propyl, isopropyl, n-butyl, ten-butyl, n-pentyl and/or phenyl.

Preferably, R³ in formula (II) is methylene, ethylene, n-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene or phenylbutylene. More preferably, R³ is phenylene or naphthylene. Suitable phosphinates are described in WO-A 97/39053, the content of which in relation to the phosphinates is encompassed by the present specification. Particularly preferred phosphinates in the sense of the present invention are aluminium salts and zinc salts of dimethylphosphinate, of ethylmethylphosphinate, of diethylphosphinate and of methyl-n-propylphosphinate and also mixtures thereof.

In formula (I), m is preferably 2 and 3, more preferably 3.

In formula (II), n is preferably 1 and 3, more preferably 3.

In formula (II), x is preferably 1 and 2, more preferably 2.

Used with very particular preference as component B) is aluminium tris(diethylphosphinate) [CAS No. 225789-38-8], which is available, for example, from Clariant International Ltd. Muttenz, Switzerland under the trade name Exole® OP1230 or Exolit® OP1240.

Component C)

Employed as component C) is at least one inorganic phosphate salt from the group of metal hydrogen phosphates, metal dihydrogen phosphates, metal dihydrogen pyrophosphates and/or metal pyrophosphates, metal in component C) being sodium, potassium, magnesium, zinc, copper and/or aluminium.

The inorganic phosphate salt for use in accordance with the invention as component C) includes the corresponding hydrates.

Preferred metals of component C) are sodium, potassium, magnesium, zinc, or aluminium. Particularly preferred metals are magnesium and/or zinc. Especially preferred as metal is zinc. Especially preferred as metal is also magnesium.

Employed as component C) with preference are those inorganic phosphate salts which have a pH in the range from 2 to 6, more preferably in the range from 2 to 4, the figures for the pH being based here on aqueous medium at 20° C. at a concentration of 1 g per litre.

Employed with preference from the group of the metal dihydrogen pyrophosphates and metal pyrophosphates are sodium dihydrogen pyrophosphate [CAS No. 7758-16-9], magnesium pyrophosphate [CAS No. 13446-24-7] and zinc pyrophosphate [CAS No. 7446-26-6], with zinc pyrophosphate being particularly preferred. The latter is available, for example, under the name Z34-80 from Chemische Fabrik Budenheim KG, Budenheim, Germany.

From the group of the metal hydrogenphosphates, preference is given to using magnesium hydrogenphosphate [CAS No. 7757-88-0], zinc hydrogenphosphate [CAS No. 7864-38-2] or calcium hydrogenphosphate. The latter is preferably used in the form of its dihydrate, calcium hydrogenphosphate dihydrate, CaHPO₄.2H₂O [CAS Nr. 7789-77-7].

From the group of metal dihydrogen phosphates for preferred use in particular as component C), preference is given to using aluminium dihydrogen phosphate [CAS No. 13530-50-2], magnesium bis(dihydrogen phosphate) [CAS No. 13092-66-5], zinc bis(dihydrogen phosphate) [CAS No. 13598-37-3] and zinc bis(dihydrogen phosphate) dihydrate [CAS No. 13986-21-5], with zinc bis(dihydrogen phosphate) and zinc bis(dihydrogen phosphate) dihydrate being very particularly preferred and zinc bis(dihydrogen phosphate) dihydrate being especially preferred. The latter is available, for example, under the name Z21-82 from Chemische Fabrik Budenheim KG, Budenheim, Germany. Very especially preferred is magnesium bis(dihydrogenphosphate).

The compounds of component C) can be used individually or as a mixture, optionally with addition of calcium pyrophosphate [CAS No, 7790-76-3] or with calcium hydrogen phosphate or with or calcium hydrogenphosphate dihydrate.

Component D)

According to the invention, at least one condensed melamine derivative is used as component D). Preferred condensation products of melamine are melam [CAS No, 3576-88-3], melem [CAS No. 1502-47-2] or melon [CAS No, 32518-77-7], and mixtures thereof.

Preparation is possible, according to https://de.wikipedia.org/wiki/Melem_(Verbindung), for example by condensation of cyanamide, ammonium dicyanamide, dicyandiamide or melamine, synthesis proceeding over several stages. Dicyandiamide is first formed from cyanamide or ammonium dicyanamide and is then cyclized to give melamine. Condensation of melamine, with release of ammonia, leads directly or via the intermediate compound melam to the target compound.

Particular preference is given in accordance with the invention to using melem as component D), very particular preference being given to melem qualities with a melamine content of less than 1.0% by weight, the content of melamine being determined via NIR FT-IR.

Melem for use as component D) in accordance with the invention is supplied, for example, as Delace® NFR from Delamin Ltd., Derby, UK.

Component E)

As component E), at least one melamine derivative other than component D) is used. Preference is given to using, as component E), reaction products of melamine with acids. Particular preference is given to using, as component E), melamine cyanurate, melamine polyphosphate or melamine-intercalated aluminium salts, zinc salts or magnesium salts of condensed phosphates. The latter are described in WO2012/025362 A1, the contents of which are hereby fully encompassed.

Very particular preference is given to using, as component E), melamine cyanurate, melamine polyphosphate, bismelamine zincodiphosphate (EP 2 609 173 A1) or bismelamine aluminotriphosphate (EP 2 609 173 A1).

Especial preference is given to using, as component E), melamine polyphosphate or melamine cyanurate. Very especial preference is given to using, as component E), melamine cyanurate.

Melamine polyphosphate [CAS No. 218768-84-4] is available commercially in diverse product grades. Examples thereof include Melapur® 200/70 from BASF, Ludwigshafen, Germany, and also Budit® 3141 from Budenheim, Budenheim, Germany. Melamine cyanurate [CAS No. 37640-57-6] is available commercially in diverse product grades. Examples of this include Melapur® MC25 from BASF, Ludwigshafen, Germany,

Component F)

As component F), at least one metal sulphate is used. Preferred metal sulphates are magnesium sulphate, calcium sulphate [CAS No. 7776-18-9] or barium sulphate. Particular preference is given to using, as component F), magnesium sulphate [CAS No. 7487-88-9] or barium sulphate.

Barium sulphate [CAS No, 772743-7], which is to be used with especial preference as component F), can be used in the form of naturally occurring baryte or in the form of barium sulphate produced synthetically by known industrial methods. Customary preparation methods for barium sulphate taught in http://de.wikipedia.org/Wiki/Bariumsulfat, for example, are the precipitation of barium sulphide or barium chloride with sodium sulphate. The average particle size [d50] in this case is preferably in the range from (11 to 50 μm, more preferably in the range from 0.5 to 10 μm and very preferably in the range from 0.6 to 2 μm. The barium sulphate here may be untreated or may have been equipped with organic and/or inorganic surface treatments. Examples of inorganic or organic surface treatments and also methods for the application thereof to the surface are taught in WO 2008/023074 A1 for example. Suitable synthetic barium sulphates are available, for example, from Sachtleben Chemie GmbH, Duisburg, Germany under the trade names Blanc fixe F and Blanc Fixe Super F.

Further suitable barium sulphate qualities are, for example, Albasoft® 90 and/or Albasoft® 100 from Deutsche Band Industrie Dr. Rudolf Alberti GmbH&Co. KG, Bad Lauterberg im Harz, Germany,

Component G)

As component G), the compositions, moulding compounds and products comprise at least one filler and/or reinforcer other than components A) to F). Preference is also given to a mixture of two or more different fillers and/or reinforcers.

Preference is given to using at least one filler and/or reinforcer from the group of mica, silicate, quartz, especially quartz flour, titanium dioxide, wollastonite, nepheline syenite, amorphous silicas, magnesium carbonate, chalk, feldspar, glass fibres, glass beads, ground glass and/or fibrous fillers and/or reinforcers based on carbon fibres as component G).

Preference is given to using particulate mineral fillers and/or reinforcers based on mica, silicate, quartz, wollastonite, kaolin, amorphous silicas, magnesium carbonate, chalk or feldspar. Particular preference is additionally also given to using acicular mineral fillers. According to the invention, acicular mineral fillers and/or reinforcers are understood to mean a mineral filler having a very marked acicular character. The acicular mineral filler and/or reinforcer preferably has a length:diameter ratio in the range from 2:1 to 35:1, more preferably in the range from 3:1 to 19:1, most preferably in the range from 4:1 to 12:1. The median particle size d50 of the acicular minerals for use in accordance with the invention is preferably less than 20 μm, more preferably less than 15 μm, especially preferably less than 10 μm, determined with a CILAS GRANULOMETEA according to ISO 13320:2009 by means of laser diffraction.

As a result of their processing to the moulding compound or to a product, all fillers and/or reinforcers that can be used as component G) may have a smaller d97 or d50 within these moulding compounds or products than the fillers and/or reinforcers and/or glass fibres originally employed.

The fillers and/or reinforcers can be used individually or as a mixture of two or more different fillers and/or reinforcers.

The filler and/or reinforcer to be used as component G) may in one preferred embodiment be surface-modified, more preferably with an adhesion promoter or adhesion promoter system, especially preferably an epoxide-based one. However, pretreatment is not absolutely necessary.

In one particularly preferred embodiment, glass fibres are used as component G). According to “http://de.wikipedia.org/wiki/Faser-Kunststoff-Verbund”, a distinction is made between chopped fibres, also known as short fibres, having a length in the range from 0.1 to 1 mm, long fibres having a length in the range from 1 to 50 mm and continuous fibres having a length L>50 mm. Short fibres are used in injection moulding technology and can be processed directly by means of an extruder. Long fibres can likewise still be processed in extruders. Said fibres are widely used in fibre spraying. Long fibres are frequently added to thermosets as a filler. Continuous fibres are used in the form of ravings or fabric in fibre-reinforced plastics. Products comprising continuous fibres achieve the highest stiffness and strength values. Further available are ground glass fibres, the length of these after grinding typically being in the range from 70 to 200 μm.

Preference is given in accordance with the invention to using, as component G), chopped long glass fibres having an initial length in the range from 1 to 50 mm, more preferably in the range from 1 to 10 mm and very preferably in the range from 2 to 7 mm. Starting length refers to the average length of the glass fibres as present prior to compounding of the composition(s) according to the invention to give a moulding compound according to the invention. In the moulding compound or in the product, the glass fibres for use with preference as component G) may have a smaller d97 and/or d50 than the glass fibres originally employed, as a result of processing, especially compounding, to give the moulding compound or the product. Thus, the arithmetic mean of the glass fibre length after processing is frequently still only in the range from 150 μm to 300 μm.

The glass fibre length and glass fibre length distribution are determined in the context of the present invention, in the case of processed glass fibres, according to ISO 22314, which first stipulates ashing of the samples at 625° C. Subsequently, the ash is placed onto a microscope slide covered with demineralized water in a suitable crystallizing dish, and the ash is distributed in an ultrasound bath with no action of mechanical forces. The next step involves drying in an oven at 130° C., followed by the determination of the glass fibre length with the aid of light microscopy images. For this purpose, at least 100 glass fibres are measured in three images, and so a total of 300 glass fibres are used to ascertain the length. The glass fibre length either can be calculated as the arithmetic mean lₒ according to the equation

$${I}_{\text{?}} = \frac{\text{?}}{n} , {\sum }_{\text{?}}^{\text{?}} \text{?} \\ \text{?} \text{indicates text missing or illegible when filed} \qquad$$

where lₗ=length of the ith fibre and n=number of fibres measured, and represented appropriately as a histogram, or else, in the case of an assumed normal distribution of the measured glass fibre lengths l, it can be determined by means of the Gaussian function in accordance with the equation

$$f ( I ) = \frac{1}{\sqrt{2 π} \cdot σ} \cdot {e}^{\text{?}} \frac{\text{?}}{\text{?}} {( \frac{\text{?} - \text{?}}{\text{?}} )}^{\text{?}}$$

$$\text{?} \text{indicates text missing or illegible when filed}$$

In this equation, lₒ and σ are specific parameters of the normal distribution: lₒ is the mean and σ is the standard deviation (see: M. Schoβig, Schadigungsmechanismen in faserverstärkten Kunststoffen [Damage Mechanisms in Fibre-Reinforced Plastics], 1, 2011, Vieweg and Teubner Verlag, page 35, ISBN 978-3-83418-1483-4 Glass fibres not incorporated into a polymer matrix are analysed with respect to their lengths by the above methods, but without processing by ashing and separation from the ash.

The glass fibres [CAS No, 65997-17-3] for use with preference in accordance with the invention as component G) preferably have a fibre diameter in the range from 7 to 18 μm, more preferably in the range from 9 to 15 μm, which can be determined by at least one facility available to the skilled person, in particular by computer x-ray microtomography in analogy to “Quantitative Messung von Faserëngen und -verteilung in faserverstärkten Kunststoffteilen mittels μ-Röntgen-Computerlomographie” Quantitative measurement of fibre lengths and fibre distribution in fibre-reinforced plastic components by computer x-ray microtomography], J. KASTNER, et al. DGZIP-Jahrestagung 2007-paper 47. The glass fibres for preferred use as component G) are added preferably as continuous fibres or as chopped or ground glass fibres.

In one embodiment, the fillers and/or reinforcers for use as component G), more particularly glass fibres, are preferably equipped with a suitable size system and with an adhesion promoter or adhesion promoter system, more preferably one based on silane.

Especially preferred silane-based adhesion promoters for pretreatment are silane compounds of the general formula (IV)

(X—(CH₂)_{q})ₖ—Si—(O—CrH₂ᵣ₊₁)₄₋ₖ (IV)

in which the substituents are defined as follows:

X: NH₂—, HO—,

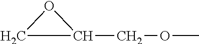

q: an integer from 2 to 10, preferably from 3 to 4,

r: an integer from 1 to 5, preferably from 1 to 2,

k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyitriethoxysilane and the corresponding silanes comprising a glycidyl group as the substituent X.

For the modification of the glass fibres, the silane compounds are used preferably in amounts in the range from 0.05% to 2% by weight, more preferably in the range from 0.25% to 1.5% by weight and more particularly in the range from 0.5% to 1% by weight, based on 100% by weight of the filler and/or reinforcer, more particularly the glass fibres, for the surface coating.

Component H)

Preferred further additives other than component B) to G) that are to be used as component H) are lubricants and demoulding agents, UV stabilizers, colourants, chain-extending additives, antioxidants, plasticizers, flow auxiliaries, thermal stabilizers, gamma ray stabilizers, hydrolysis stabilizers, elastomer modifiers, antistats, emulsifiers, nucleating agents, processing aids, anti-drip agents and further flame retardants other than components B), C) and, if appropriate, E).

The additives can be used alone or in admixture/in the form of masterbatches.

Preference is given to using halogen-free additives for the reasons mentioned above.

Lubricants and demoulding agents are preferably selected from at least one of the series of long-chain fatty adds, salts of long-chain fatty adds, ester derivatives of long-chain fatty adds and montan waxes.

Preferred long-chain fatty adds are stearic add or behenic add. Preferred salts of the long-chain fatty adds are calcium or zinc stearate. Preferred ester derivatives of long-chain fatty adds are those based on pentaerythritol, more particularly C₁₆-C₁₈ fatty add esters of pentaerythritol [CAS No. 68604-44-4] or [CAS No. 85116-93-4].

Montan waxes in the context of the present invention are mixtures of straight-chain saturated carboxylic adds having chain lengths of from 28 to 32 carbon atoms. Particular preference is given in accordance with the invention to using lubricants and/or demoulding agents from the group of esters of saturated or unsaturated aliphatic carboxylic acids having 8 to 40 carbon atoms with aphatic saturated alcohols having 2 to 40 carbon atoms and metal salts of saturated or unsaturated aliphatic carboxylic acids comprising 8 to 40 carbon atoms, very particular preference being given here to pentaerythritol tetrastearate, calcium stearate [CAB No. 1592-23-0] and/or ethylene glycol dimontanate, here in particular Licowax® E [CAS No. 74388-220] from Clariant, Muttenz, Basle, and very particular preference in particular to pentaerythritol tetrastearate [CAS No. 115-83-3], for example available as Loxiol® P861 from Emery Oleochemicals GmbH, Düsseldorf, Germany.

UV stabilizers used with preference are substituted resorcinols, salicylates, benzotriazoles, triazine derivatives or benzophenones.

Colourants used with preference are organic pigments, preferably phthalocyanines, quinacridones, perylenes and dyes, preferably nigrosin or anthraquinones, and also inorganic pigments, especially titanium dioxide (if not already used as filler), ultramarine blue, iron oxide, zinc sulphide or carbon black.

Useful titanium dioxide pigments for the titanium dioxide for use with preference as pigment in accordance with the invention are those whose parent oxides can be produced by the sulphate (SP) or chloride (CP) process and have anatase and/or rutile structure, preferably rutile structure. The parent oxide does not have to be stabilized, but a specific stabilization is preferred: in the CP parent oxide by an Al doping of 0.3-3.0% by weight (calculated as Al₂O₃) and an oxygen excess in the gas phase in the oxidation of the titanium tetrachloride to form titanium dioxide of at least 2%; in the case of the SP parent oxide by doping with, for example, Al, Sb, Nb or Zn. Particular preference is given to “light” stabilization with Al, or in the case of higher amounts of Al doping to compensation with antimony. It is known that when using titanium dioxide as white pigment in paints and coatings, plastics materials etc. unwanted photocatalytic reactions caused by UV absorption lead to decomposition of the pigmented material. This involves absorption of light in the near ultraviolet range by titanium dioxide pigments, forming electron-hole pairs, which produce highly reactive free radicals on the titanium dioxide surface. The free radicals formed result in binder decomposition in organic media. With preference in accordance with the invention, the photoactivity of the titanium dioxide is lowered by inorganic aftertreatment thereof, more preferably with oxides of Si and/or Al and/or Zr and/or through the use of Sn compounds.

It is preferable when the surface of titanium dioxide pigment has a covering of amorphous precipitated oxide hydrates of the compounds SiO₂ and/or Al₂O₃ and/or zirconium oxide. The Al₂O₃ shell facilitates pigment dispersion into the polymer matrix; the SiO₂ shell makes it more difficult for charge exchange to take place at the pigment surface, and so prevents polymer breakdown.

In accordance with the invention the titanium dioxide is preferably provided with hydrophilic and/or hydrophobic organic coatings, in particular with siloxanes or polyalcohols.

Titanium dioxide (CAS No. 13463-67-71 for use with preference in accordance with the invention as colourant of component H) preferably has a median particle size d50 in the range from 90 nm to 2000 nm, more preferably in the range from 200 nm to 800 nm. The median particle size d50 is the value determined from the particle size distribution at which 50% by weight of the particles have an equivalent sphere diameter smaller than this d50 value. The underlying standard is ISO 13317-3.

The statements of the particle size distribution and average particle size for titanium dioxide are based on so-called surface-based particle sizes, in each case before incorporation into the thermoplastic moulding compound. The particle size is determined in accordance with the invention by laser diffractometry; see C. M. Keck, Moderne Pharmazeutische Technologie [Modern Pharmaceutical Technology] 2009, Free University of Berlin, Chapter 3.1. or QUANTACHROME PARTIKELWELT NO 6, June 2007, pages 1 to 16.

Examples of commercially available titanium dioxide include Kronos 2230, Kronos® 2233, Kronos® 2225 and Kronos® 47000 from Kronos, Dallas, USA.

Preference is given to using the titanium dioxide for use as pigment in amounts in the range from 0.1 to 60 parts by mass, more preferably in amounts in the range from 1 to 35 parts by mass, most preferably in amounts in the range from 2 to 20 parts by mass, based in each case on 100 parts by mass of component A).

It is possible with preference to use, as component H), di- or polyfunctional branching or chain-extending additives containing at least two and not more than 15 branching or chain-extending functional groups per molecule. Suitable branching or chain-extending additives include low molecular mass or oligomeric compounds which possess at least two and not more than 15 functional groups with branching or chain-extending activity per molecule, and which are able to react with primary and/or secondary amino groups, and/or amide groups and/or carboxylic acid groups. Chain-extending functional groups are preferably isocyanates, alcohols, blocked isocyanates, epoxides, maleic anhydrides, oxazoline, oxazine, oxazolone, preference being given to epoxides.

Particularly preferred di- or polyfunctional branching or chain-extending additives are diepoxides based on diglycidyl ethers (bisphenol and epichlorohydrin), based on amine epoxy resin (aniline and epichlorohydrin), based on diglycidyl esters (cycloaliphatic dicarboxylic acids and epichlorohydrin), individually or in mixtures, and also 2,2-bis[p-hydroxyphenyl[propane diglycidyl ether, bis[p-(N-methyl-N-2,3-epoxypropylamino)phenyl]methane and epoxidized fatty acid esters of glycerol comprising at least two and no more than 15 epoxy groups per molecule.

Particularly preferred di- or polyfunctional branching or chain-extending additives are glycidyl ethers, very particularly preferably bisphenol A diglycidyl ether [CAS No. 98460-24-3] or epoxidized fatty acid esters of glycerol, and also very particularly preferably epoxidized soya oil [CAS No. 8013-07-8].

Also particularly preferably suitable for branching/chain extension are:

1. Poly- or oligoglycidyl or poly(β-methylglycidyl) ethers, obtainable by reaction of a compound comprising at least two tree alcoholic hydroxy groups and/or phenolic hydroxy groups with a suitably substituted epichlorohydrin under alkaline conditions, or in the presence of an acidic catalyst with subsequent alkali treatment.

Poly- or oligoglycidyl or poly(β-methylglycidyl) ethers preferably derive from acyclic alcohols, in particular ethylene glycol, diethylene glycol and higher poly(oxyethylene) glycols, propane-1,2-diol, poly(oxypropylene) glycols, propane-1,3-diol, butane-1,4-diol, poly(oxytetramethylene) glycols, pentane-1,5-diol, hexane-1,6-diol, hexane-2,4,6-trial, glycerol, 1,1,1-trimethylpropane, bistrimethylolpropane, pentaerythritol, sorbitol, or from polyepichlorohydrins.

However, said ethers also preferably derive from cycloaliphatic alcohols, in particular 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or they comprise aromatic nuclei, in particular N,N-bis(2-hydroxyethyl)aniline or p,p′-bis(2-hydroxyethylamino)diphenylmethane.

The epoxy compounds may also preferably derive from monocyclic phenols, in particular from resorcinol or hydroquinone; or are based on polycyclic phenols, in particular on bis(4-hydroxyphenyl)methane, 2,2-bis(4-hydroxyphenyl)propane, 2,2-bis(3,5-dibromo-4-hydroxyphenyl)propane, 4,4′-dihydroxydiphenylsulphone or on condensation products of phenols with formaldehyde obtained under acidic conditions, in particular phenol novolacs.

2. Poly- or oligo(N-glycidyl) compounds further obtainable by dehydrochlorination of the reaction products of epichlorohydrin with amines comprising at least two amino hydrogen atoms. These amines are preferably aniline, toluidine, n-butylamine, bis(4-aminophenyl)methane, m-xylylenediamine or bis(4-methylaminophenyl)methane, or else N,N,O-triglycidyl-m-aminophenyl or N,N,O-triglycidyl-p-aminophenol.

However the poly(N-glycidyl) compounds also preferably include N,N′-diglycidyl derivatives of cycloalkyleneureas, particularly preferably ethyleneurea or 1,3-propyleneurea, and N,N′-diglycidyl derivatives of hydantoins, in particular 5,5-dimethylhydantoin.

3. Poly- or oligo(S-glycidyl) compounds, in particular di-S-glycidyl derivatives deriving from dithiols, preferably ethane-1,2-dithiol or bis(4-mercaptomethylphenyl) ether,

4. Epoxidized fatty add esters of glycerol, in particular epoxidized vegetable oils. Said esters are obtained by epoxidation of the reactive olefin groups of triglycerides of unsaturated fatty acids. Epoxidized fatty add esters of glycerol may be produced from unsaturated fatty add esters of glycerol, preferably from vegetable oils, and organic peroxycarboxylic acids (Prilezhaev reaction). Processes for producing epoxidized vegetable oils are described, for example, in Smith, March, March's Advanced Organic Chemistry (5th edition, Wiley-Interscience, New York, 2001). Preferred epoxidized fatty add esters of glycerol are vegetable oils. An epoxidized fatty add ester of glycerol particularly preferred in accordance with the invention is epoxidized soya bean oil [CAS No. 8013-07-8].

5. Glycidyl methacrylate-modified styrene-acrylate polymers obtainable by polymerization of styrene, glycidyl methacrylate and acrylic add and/or methacrylic add.

Plasticizers used with preference as component H) are dioctyl phthalate, dibenzyl phthalate, butyl benzyl phthalate, hydrocarbon oils or N-(n-butyl)benzenesulphonamide.

Flow auxiliaries used with preference as component H) are copolymers containing at least one α-olefin with at least one methacrylic ester or acrylic ester of an aliphatic alcohol. Particular preference is given to copolymers of at least one α-olefin with at least one methacrylic ester or acrylic ester of an aliphatic alcohol. Very particular preference is given to copolymers of an α-olefin and an acrylic ester of an aliphatic alcohol. Especially preferred here are copolymers where the α-olefin is formed from ethene and/or propene and the methacrylic ester or acrylic ester comprises as its alcohol component linear or branched alkyl groups having 6 to 20 carbon atoms. A copolymer of ethene and 2-ethylhexyl acrylate is very especially preferred. Copolymers suitable as flow auxiliaries in accordance with the invention are notable not only for the composition but also for the low molecular weight. Accordingly, preference is given in particular to copolymers having an MFI as measured at 190° C. under a load of 2.16 kg of at least 100 g/10 min, preferably of at least 150 g/10 min, more preferably of at least 300 g/10 min. The MFI, melt flow index, serves to characterize the flow of a melt of a thermoplastic and is subject to the standards ISO 1133 or ASTM D 1238. The MFI, and all figures relating to the MFI in the context of the present invention, relate or were measured or determined in a standard manner according to ISO 1133 at 190° C. with a test weight of 2.16 kg.

Elastomer modifiers for use with preference as component H) include one or more graft polymers of

H.1 5% to 95% by weight, preferably 30% to 90% by weight, of at least one vinyl monomer

H.2 95% to 5% by weight, preferably 70% to 10% by weight, of one or more graft bases having glass transition temperatures of <10° C., preferably <0° C., more preferably <−20° C. The percentages by weight in this case are based on 100% by weight of component H).

The graft base H.2 generally has a median particle size (d150) in the range from 0.05 to 10 μm, preferably in the range from 0.1 to 5 μm, more preferably in the range from 0.2 to 1 μm.

Monomers H.1 are preferably mixtures of

H.1.1 50% to 99% by weight of viriylaromatics and/or ring-substituted vinyiaromatics, especially styrene, α-methylstyrene, p-methylstyrene, p-chlorostyrene, and/or (C₁-C₈)-alkyl methacrylates, in particular methyl methacrylate, ethyl methacrylate, and

H.1.2 1% to 50% by weight of vinyl cyanides, especially unsaturated nitriles such as acrylonitrile and methacrylonitrile, and/or (C₁-C₈)-alkyl (meth)acryiates, especially methyl methacrylate, glycidyl methacrylate, n-butyl acrylate, t-butyl acrylate, and/or derivatives, especially anhydrides and imides, of unsaturated carboxylic acids, especially maleic anhydride or N-phenylmaleimide. The percentages by weight in this case are based on 100% by weight of component H).

Preferred monomers H.1.1 are selected from at least one of the monomers styrene, α-methylstyrene and methyl methacrylate; preferred monomers H.1.2 are selected from at least one of the monomers acrylonitrile, maleic anhydride, glycidyl methacrylate and methyl methacrylate.

Particularly preferred monomers are H.1.1 styrene and H.1.2 acrylonitrile.

Examples of graft bases H.2 suitable for the graft polymers for use in the elastomer modifiers are diene rubbers, EPO M rubbers, i.e. those based on ethylene/propylene and optionally diene, and also acrylate, polyurethane, silicone, chloroprene and ethylene/vinyl acetate rubbers. EPDM stands for ethylene-propylene-diene rubber.

Preferred graft bases H2 are diene rubbers, especially based on butadiene, isoprene, etc., or mixtures of diene rubbers or copolymers of dime rubbers or mixtures thereof with further copolymerizable monomers, especially as per H.1.1 and H.1.2, with the proviso that the glass transition temperature of component H.2 is <10° C., preferably <0° C., more preferably <−10° C.

Particularly preferred graft bases H.2 are ABS polymers (emulsion, bulk and suspension ABS), where ABS stands for acrylonitrile-butadiene-styrene, as described, for example, in DE -A 2 035 390 or in DEA 2 248 242 or in Ullmann, Enzyklopädie der Technischen Chemie, vol 19 (1980), p. 280 ff.

The elastomer modifiers/graft polymers are produced by free-radical polymerization, preferably by emulsion, suspension, solution or bulk polymerization, in particular by emulsion or bulk polymerization.

Particularly suitable graft rubbers also include ABS polymers, which are produced by redox initiation with an initiator system composed of organic hydroperoxide and ascorbic acid according to U.S. Pat. No. 4,937,285.

Since, as is well known, the graft monomers are not necessarily entirely grafted onto the graft base in the grafting reaction, graft polymers are also understood in accordance with the invention to mean products which are produced via (co)polymerization of the graft monomers in the presence of the graft base and also obtained in the workup.

Likewise suitable acrylate rubbers are based on graft bases H.2, which are preferably polymers of alkyl acrylates, optionally with up to 40% by weight, based on H.2, of other polymerizable, ethylenically unsaturated monomers. The preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, preferably chloroethyl acrylate, glycidyl esters, and mixtures of these monomers. Particularly preferred in this context are graft polymers with butyl acrylate as core and methyl methacrylates as shell, more particularly Paraloid® EXL2300, Dow Corning Corporation, Midland Mich., USA.

Further preferentially suitable graft bases as per H.2 are silicone rubbers having active grafting sites, as are described in DE-A 3 704 657, DEA 3 704 655, DEA 3 631 540 and DEA 3 631 539.

Preferred graft polymers with a silicone fraction are those which have methyl methacrylate or styrene acrylonitrile as shell and a silicone/acrylate graft as core. Those with styrene-acrylonitrile as shell that can be used include Metabien SRK200, for example. Those with methyl methacrylate as shell that can be used include Metablen® S2001, Metablen® S2030 and/or Metablen® SX-005, for example. Particularly preferred for use is Metablen® 32001, The products with the trade names Metablen® are available from Mitsubishi Rayon Co., Ltd., Tokyo, Japan.

Crosslinking may be achieved by copolymerizing monomers comprising more than one polymerizable double bond. Preferred examples of crosslinking monomers are esters of unsaturated monocarboxylic adds having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes, but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, tray isocyanurate, triacryloylhexahydro-s-triazine, triallylbenzenes. The amount of the crosslinked monomers is preferably 0.02% to 5% by weight, in particular 0.05% to 2% by weight, based on 100% by weight of the graft base H2.

In the case of cyclic crosslinking monomers having at least 3 ethylenically unsaturated groups, it is advantageous to restrict the amount to below 1% by weight, based on 100% by weight of the graft base H.2.

Preferred “other” polymerizable, ethylenically unsaturated monomers which, in addition to the acrylic esters, may optionally be used to prepare the graft base H.2 are acrylonitrile, styrene, α-methylstyrene, acrylamide, vinyl C₁-C₆alkyl ethers, methyl methacrylate, glycidyl methacrylate, butadiene. Preferred acrylate rubbers as graft base H.2 are emulsion polymers having a gel content of at least 60% by weight.

Other materials that can likewise be used, alongside elastomer modifiers based on graft polymers, are elastomer modifiers which are not based on graft polymers and have glass transition temperatures <10° C., preferably <0° C., particularly preferably <−20° C. These preferably include elastomers having a block copolymer structure and additionally thermoplastically meltable elastomers, in particular EPM, EPDM and/or SEB S rubbers (EPM=ethylene-propylene copolymer, EPDM=ethylene-propylene-diene rubber and SEBS=styrene-ethene-butene-styrene copolymer).

Preferred further flame retardants for use as component H) are different from components C) and E) and are halogen-free.

The further phosphorus-containing flame retardants for use with preference as component H) include, for example, phosphorus compounds from the group of the inorganic metal phosphinates, especially aluminium phosphinate and zinc phosphinate, of the mono- and oligomeric phosphoric and phosphonic esters, especially triphenyl phosphate (TPP), resorcinol bis(diphenylphosphate) (RDP), bisphenol A bis(diphenylphosphate) (BDP) including oligomers, polyphosphonates, especially bisphenol A-diphenyl methylphosphonate copolymers, for example Nofia™ HM1100 [CAS No. 68664-06-2] from FRX Polymers, Chelmsford, USA), and also derivatives of the 9,10-dihydro-9-oxa-10-phosohaphenanthrene 10-oxides (DOPO derivatives), phosphonate amines, metal phosphonates, especially aluminium phosphonate and zinc phosphonate, phosphine oxides and phosphazenes. Particularly preferred phosphazenes here are phenoxyphosphazene oligomers. The phosphazenes and their preparation are described for example in EP-A 728 811, DEA 1961668 and WO-A 97/40092. Particular preference is given in accordance with the invention to using cyclic phenoxyphosphazenes such as 2,2,4,6,6-hexahydro-2,2,4,4,6,6-hexaphenoxytriazatriphosphorine [CAS No. 1184-10-7] and/or those as obtainable, for example, from Fushimi Pharmaceutical Co. Ltd, Kagawa, Japan under the Rabitie® FP110 name [CAS No. 1203646-63-2].

It is likewise possible to use further nitrogen-containing flame retardants other than components C) and E) individually or in a mixture, as further flame retardant of component H).

Preferred are guanidine salts, especially guanidine carbonate, primary guanidine cyanurate, primary guanidine phosphate, secondary guanidine phosphate, primary guanidine sulphate, secondary guanidine sulphate, guanidine pentaerythrityl borate, guanidine neopentyl glycol borate, urea phosphate and urea cyanurate. It is possible, furthermore, for reaction products of melem, melam and melon with condensed phosphoric adds to be used. Likewise suitable are tris(hydroxyethyl)isocyanurate or its reaction products with carboxylic adds, benzoguanamine and its adducts and/or salts, and also products thereof that are substituted on the nitrogen, and also the salts and adducts of these. Further nitrogen-containing components suitable include allantoin compounds, and also salts thereof with phosphoric add, boric add or pyrophosphoric add, and also glycolurils or salts thereof. Other preferred nitrogen-containing flame retardants different from components C) and E) are the reaction products of trichlorotriazine, piperazine and morpholine as per CAS No. 1078142-02-5, especially MCA PPM Triazin HF from MCA Technologies GmbH, Biel-Benken, Switzerland.

Other flame retardants or flame retardant synergists not specifically mentioned here may also be employed as component H). These include, among others, purely inorganic phosphorus compounds different from component B), more particularly red phosphorus or boron phosphate hydrate. It is also possible, furthermore, to use mineral flame retardant additives or salts of aliphatic and aromatic sulphonic acids, especially metal salts of 1-perfluorobutanesulphonic acid. Additionally suitable are flame retardant synergists from the group of the oxygen-, nitrogen- or sulphur-containing metal compounds wherein metal is antimony, zinc, molybdenum, calcium, titanium, magnesium or boron, preferably antimony trioxide, antimony pentoxide, sodium antimonate, zinc oxide, zinc borate, zinc stannate, zinc hydroxystannate, zinc sulphide, molybdenum oxide, and, if not already used as colourant, titanium dioxide, magnesium carbonate, calcium carbonate, calcium oxide, titanium nitride, boron nitride, magnesium nitride, zinc nitride, calcium borate, magnesium borate or mixtures thereof.

Further flame retardant additives that are suitable and are for preferred use as component H) are char formers, more preferably poly(2,6-diphenyl-1,4-phenyl) ether, especially poly(2,6-dimethyl-1,4-phenylene) ether [CAS No. 25134-01-4], phenol-formaldehyde resins, polycarbonates, polyimides, polysulphones, polyethersulphones or polyether ketones, and also antidrip agents, especially tetrafiuoroethylene polymers. The tetrafluoroethylene polymers may be employed in pure form or else in combination with other resins, preferably styrene-acrylonitrile (SAN), or acrylates, preferably methyl methacrylate and/or butyl acrylate. An especially preferentially suitable example of tetrafluoroethylerie-styrene-acrylonitrile resins is, for example, Cycolac® INP 449 [CAS No. 1427354-85-91 from Sabic Corp., Riyadh, Saudi Arabia; an especially preferentially suitable example of tetrafluoroethylene-acrylate resins is, for example, Metablen A3800 [CAS No. 639808-21-2] from Mitsubishi Rayon Co., Ltd., Tokyo, Japan. Antidrip agents comprising tetrafluoroethylene polymers are used in accordance with the invention as component H) preferably in amounts in the range from 0.01 to 5 parts by mass, more preferably in the range from 0.05 to 2 parts by mass, based in each case on 100 parts by mass of component A).

If required for the use, it is also possible in one embodiment of the present invention to use, as component H), halogenated flame retardants other than components C) and E). These include standard organic halogen compounds with or without synergists. Halogenated, especially brominated and chlorinated, compounds preferably include ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene and brominated polyphenylene ethers.

The flame retardants for additional use as component H) can be added to the polyalkylene terephthalate or polycycloalkylene terephthalate in pure form, and also via masterbatches or compacted preparations.

Heat stabilizers for preferred use as component H) are selected from the group of sulphur-containing stabilizers, especially sulphides, dialkylthiocarbamates or thiodipropionic acids, and also those selected from the group of the iron salts and the copper salts, in the latter case especially copper(I) iodide, being used preferably in combination with potassium iodide and/or sodium hypophosphite NaH₂PO₂, and also sterically hindered amines, especially tetramethylpiperidine derivatives, aromatic secondary amines, especially diphenylamines, hydroquinones, substituted resorcinois, salicylates, benzotriazoles and benzophenones, and also stericaily hindered phenols and aliphatically or aromatically substituted phosphites, and also differently substituted representatives of these groups.

Among the sterically hindered phenols preference is given to employing those having at least one 3-tert-butyl-4-hydroxy-5-methylphenyl building block and/or at least one 3,5-di(tert-butyl-4-hydroxyphenyl) building block, particular preference being given to 1,6-hexanediol bis[3-(3,5-di-tert-butyl-4-hydroxyphenyl)propionate] [CAS No. 35074-77-2] (Irganox® 259 from BASF SE, Ludwigshafen, Germany), pentaerythritol tetrakis[3-(3,5-di-tert-butyl-4-hydroxyphenyl)propionate] [CAS No. 6683-19-8] (Irganox® 1010 from BASF SE) and 3,9-bis[2-[3-(3-tert-butyl-4-hydroxy-5-methylphenyl)propionyloxy]-1,1-dimethylethyl]-2,4,8,10-tetraoxaspiro[6,5]undecane [CAS No. 90498-90-1] (ADK Stab® AO 80). ADK Stab® AO 80 is commercially available from Adeka-Palmerole SAS, Mulhouse, France.

Among the aliphatically or aromatically substituted phosphites for use, preference is given to bis(2,4-dicumylphenyl)pentaerythritol diphosphite [CAS No. 154862-43-8], which is available for example from Dover Chemical Corp., Dover, USA under the trade name Doverphos® S9228, and tetrakis(2,4-di-tert-butylphenyl)-1,1-biphenyl-4,4′-diyl bisphosphonite [CAS No. 38613-77-3], which can be obtained, for example, as Hostanox® P-EPO from Clariant International Ltd., Muttenz, Switzerland.

The preparation of moulding compounds of the invention for further utilization takes place by mixing of the compositions of the invention in at least one mixer, preferably compounder. This gives, as intermediates, moulding compounds based on the compositions of the invention. These moulding compounds—also referred to as thermoplastic moulding compounds—may either consist exclusively of components A), B) and C) or A), B), C), D) and E), or else may comprise further components.

In case the moulding compounds consist exclusively of components A), B) and C) a preferred embodiment of the present invention relates to compositions and moulding compounds producible therefrom and also products comprising A) polybutylene terephthalate, B) aluminium trisdiethylphosphinate and as C) zinc bis(dihydrogenphosphate).

In a preferred embodiment, the present invention also relates to compositions and moulding compounds producible therefrom and also products comprising A) polybutylene terephthalate, B) aluminium trisdiethylphosphinate and as C) zinc bis(dihydrogenphosphate) dihydrate.

In a preferred embodiment, the present invention also relates to compositions and moulding compounds producible therefrom and also products comprising A) polybutylene terephthalate, B) aluminium trisdiethylphosphinate and as C) zinc pyrophosphate.

In a preferred embodiment, the present invention also relates to compositions and moulding compounds producible therefrom and also products comprising A) polybutylene terephthalate, B) aluminium trisdiethylphosphinate, as C) zinc bis(dihydrogenphosphate) dihydrate and E) melamine cyanurate.

In a preferred embodiment, the present invention also relates to compositions and moulding compounds producible therefrom and also products comprising A) polybutylene terephthalate, B) aluminium trisdiethylphosphinate, as C) zinc bis(dihydrogenphosphate) dihydrate, E) melamine cyanurate and G) glass fibres.

The preparation of moulding compounds of the invention for further utilization takes place by mixing of the compositions of the invention in at least one mixer, preferably compounder. This gives, as intermediates, moulding compounds based on the compositions of the invention. These moulding compounds—also referred to as thermoplastic moulding compounds—may either consist exclusively of components A), B) and C) or A), B), C), D) and E), or else may comprise further components.

In another embodiment the present invention refers to compositions and to mouldings wherein 100 parts by weight of component A) are combined with component B) in the range from 5 to 50 parts by weight and component C) in the range from 0.001 to 4 parts by weight.

In case the moulding compounds consist exclusively of components A), B), C), D) and E) a preferred embodiment of the present invention relates to halogen-free compositions and to moulding compounds and products producible therefrom, comprising A) polybutylene terephthalate, B) aluminium tris(diethylphosphinate), C) magnesium bis(dihydrogenphosphate), D) melem and E) melamine cyanurate.

In a preferred embodiment, the present invention additionally relates to halogen-free compositions and to moulding compounds and products producible therefrom, comprising A) polybutylene terephthalate, B) aluminium tris(diethylphosphinate), C) magnesium bis(dihydrogenphosphate), D) melem E) melamine cyanurate and F) barium sulphate,

In a preferred embodiment, the present invention additionally relates to halogen-free compositions and to moulding compounds and products producible therefrom, comprising A) polybutylene terephthalate, B) aluminium tris(diethylphosphinate), C) magnesium bis(dihydrogenphosphate), D) melem, E) melamine cyanurate, F) barium sulphate and G) glass fibres, preferably glass fibres of E glass, more preferably glass fibres having a mean fibre diameter in the range of 10 to 12 μm and/or having a mean fibre length of 4.5 mm.

In a preferred embodiment, the present invention additionally relates to halogen-free compositions and to moulding compounds and products producible therefrom, comprising A) polybutylene terephthalate, B) aluminium tris(diethylphosphinate), C) aluminium tris(dihydrogenphosphate), D) melem and E) melamine cyanurate

In a preferred embodiment, the present invention additionally relates to halogen-free compositions and to moulding compounds and products producible therefrom, comprising A) polybutylene terephthalate, B) aluminium tris(diethylphosphinate), C) aluminium tris(dihydrogenphosphate), D) melem, E) melamine cyanurate and F) barium sulphate.

In a preferred embodiment, the present invention additionally relates to halogen-free compositions and to moulding compounds and products producible therefrom, comprising A) polybutylene terephthalate, B) aluiminium tris(diethylphosphinate), C) aluminium tris(dihydrogenphosphate), D) melem, E) melamine cyanurate, F) barium sulphate and G) glass fibres, preferably glass fibres of E glass, more preferably glass fibres having a mean fibre diameter in the range of 10 to 12 μm and/or having a mean fibre length of 4.5 mm.

In a preferred embodiment, the present invention additionally relates to halogen-free compositions and to moulding compounds and products producible therefrom, comprising A) polybutylene terephthalate, B) aluminium tris(diethylphosphinate), C) zinc bis(dihydrogenphosphate), D) melem and E) melamine cyanurate.

In a preferred embodiment, the present invention additionally relates to halogen-free compositions and to moulding compounds and products producible therefrom, comprising A) polybutylene terephthalate, B) aluminium tris(diethylphosphinate), C) zinc bis(dihydrogenphosphate), D) melem, E) melamine cyanurate and F) barium sulphate.

In a preferred embodiment, the present invention additionally relates to halogen-free compositions and to moulding compounds and products producible therefrom, comprising A) polybutylene terephthalate, B) aluminium tris(diethylphosphinate), C) zinc bis(dihydrogenphosphate), D) coelom, E) melamine cyanurate, F) barium sulphate and G) glass fibres, preferably glass fibres of E glass, more preferably glass fibres having a mean fibre diameter in the range of 10 to 12 μm and/or having a mean fibre length of 4.5 mm.

In a preferred embodiment, the present invention additionally relates to halogen-free compositions and to moulding compounds and products producible therefrom, comprising A) polybutylene terephthalate, B) aluminium tris(diethylphosphinate), C) zinc bis(dihydrogenphosphate) dihydrate, D) melem and E) melamine cyanurate.

In a preferred embodiment, the present invention additionally relates to halogen-free compositions and to moulding compounds and products producible therefrom, comprising A) polybutylene terephthalate, B) aluminium tris(diethylphosphinate), C) zinc bis(dihydrogenphosphate) dihydrate, D) melem, E) melamine cyanurate and F) barium sulphate.

In a preferred embodiment, the present invention additionally relates to halogen-free compositions and to moulding compounds and products producible therefrom, comprising A) polybutylene terephthalate, B) aluminium tris(diethylphosphinate), C) zinc bis(dihydrogenphosphate) dihydrate, D9 melem, E) melamine cyanurate, F) barium sulphate and G) glass fibres, preferably glass fibres of E glass, more preferably glass fibres having a mean fibre diameter in the range of 10 to 12 μm and/or having a mean fibre length of 4.5 mm.

Use

The present invention, however, also relates to the use of the compositions of the invention, especially in the form of moulding compounds, for producing tracking-resistant products, especially electrical or electronic assemblies and components.

The present invention, however, also relates to the use of the compositions of the invention for boosting the tracking resistance of polyester-based products, preferably of products of the electrical or electronics industry, more particularly products of the electrical or electronics industry where the polyester used is at least one polyalkylene terephthalate and/or at least one polycycloalkylene terephthalate, in particular at least polybutylene terephthalate.

The present invention also relates to the use of components B), C), D) and E) for production of halogen-free polyester-based compositions, moulding compounds and products, preferably leakage current-resistant products, more preferably electrical or electronic assemblies and components, wherein the polyester is selected from the group of the polyalkylene terephthalates and polycycloalkylene terephthalate.

The present invention also relates to the use of components B), C), D) and E) for enhancing the leakage current resistance of halogen-free polyester-based products, preferably of products for the electrical or electronics industry where the polyester used is at least one polyalkylene terephthalate and/or at least one polycycloalkylene terephthalate, in particular at least polybutylene terephthalate.

Method

The formulation of halogen-free moulding compounds according to the invention for further use is effected by mixing at least components A), B), C), D) and E) in at least one mixing apparatus, preferably a compounder. This affords, as intermediates, moulding compounds based on the compositions according to the invention. The moulding compounds are ultimately used to produce products by suitable methods.

The present invention also relates to a process for producing halogen-free products, preferably for the electrical or electronics industries, more preferably electronic or electric assemblies and components, by mixing compositions according to the invention to give a moulding compound, discharging it in the form of an extrudate, cooling the extrudate until it is pelletizable and pelletizing it, and finally subjecting the pelletized material in the form of a matrix material to an injection moulding or extrusion operation, preferably an injection moulding operation. In one embodiment, the moulding compound can be sent directly to the injection moulding or an extrusion without discharging it to form an extrudate and pelletizing it.

The present invention, however, also relates to a method for producing products, preferably for the electrical or electronics industry, more preferably electronic or electrical assemblies and components, by mixing compositions of the invention to form a moulding compound. These moulding compounds may additionally be discharged in the form of a strand, cooled until pelletizable and pelletized, before being subjected as a matrix material to injection moulding or extrusion, preferably injection moulding.

Preference is given to mixing at temperatures in the range from 240 to 310° C., preferably in the range from 260 to 300° C., more preferably in the range from 270 to 295° C., in the melt. Especially preferably, a twin-screw extruder is used for this purpose.

In one embodiment, the pellets comprising the composition of the invention are dried, preferably at temperatures in the range around 120° C. in a vacuum drying cabinet or in a dry air drier, for a duration in the region of 2 hours, before being subjected, as matrix material, to injection moulding or an extrusion process in order to produce products according to the invention.

The present invention, however, also relates to a method for improving the tracking resistance of polyester-based products, by processing compositions of the invention in the form of moulding compounds as matrix material by injection moulding or extrusion and using as polyester at least one polyalkylene terephthalate and/or at least one polycycloalkylene terephthalate, more particularly at least polybutylene terephthalate.

The present invention also relates to a method of improving the leakage current resistance of polyester-based, halogen-free products, by processing at least components B), C), D) and E) together with component A) as compositions to give moulding compounds and subjecting them to an injection moulding or extrusion operation, the polyester used being at least one polyalkylene terephthalate and/or at least one polycycloalkylene terephthalate, especially at least polybutylene terephthalate.

The processes of injection moulding and of extrusion of thermoplastic moulding compounds are known to those skilled hi the art.

Methods according to the invention for producing polyester-based products by extrusion or injection moulding operate at melt temperatures in the range from 240 to 330° C., preferably in the range from 260 to 300° C., more preferably in the range from 270 to 290° C., and also, optionally, at pressures of not more than 2500 bar, as well, preferably at pressures of not more than 2000 bar, more preferably at pressures of not more than 1500 bar and very preferably at pressures of not more than 750 bar.

Sequential coextrusion involves expelling two different materials successively in alternating sequence. In this way, a preform having a different material composition section by section in the extrusion direction is formed. Particular sections of articles can be equipped with specifically required properties by means of corresponding selection of material, as for example for articles having soft ends and a hard middle part, or having integrated soft bellows regions (Thielen, Hartwig, Gust, “Blasformen von Kunststofthohlkörpern”, Carl Danser Verlag, Munich 2006, pages 127-129).

A feature of the process of injection moulding is that a moulding compound comprising the compositions of the invention, preferably in pellet form, is malted in a heated cylindrical cavity (i.e. is plasticized) and is injected as an injection compound under pressure into a heated cavity. After the cooling (solidification) of the material, the injection moulding is demoulded.

The following phases are distinguished:

1. Plastification/melting

2. Injection phase (filling operation)

3. Hold pressure phase (owing to thermal contraction in the course of crystallization)

4. Remoulding.

In this regard, see http://de.wikipedia.org/wiki/Spritzgle%C3%9Fen. An injection moulding machine consists of a closure unit, the injection unit, the drive and the control system. The closure unit includes fixed and movable platens for the mould, an end platen, and tie bars and drive for the movable mould platen (toggle joint or hydraulic closure unit).

An injection unit comprises the electrically heatable barrel, the drive for the screw (motor, gearbox) and the hydraulics for moving the screw and the injection unit. The task of the injection unit is to melt the powder or the pellets, to meter them, to inject them and to maintain the hold pressure (owing to contraction). The problem of the melt flowing backward within the screw (leakage flow) is solved by non-return valves.

In the injection mould, the incoming melt is then separated and cooled, and hence the product to be produced is produced. Two halves of the mould are always needed for this purpose. In injection moulding, the following functional systems are distinguished:
runner system
shaping inserts
venting
machine casing and force absorber
demoulding system and movement transmission
heating

In contrast to injection moulding, extrusion uses a continuously shaped polymeric strand of a moulding compound of the invention in the extruder, the extruder being a machine for producing shaped thermoplastic pieces. Reference here may be made to http://de.wikipedia,org/wiki/Extrusionsblasformen. A distinction is made between single-screw extruders and twin-screw extruders, and also the respective sub-groups of conventional single-screw extruders, conveying single-screw extruders, contra-rotating twin-screw extruders and co-rotating twin-screw extruders.

Extrusion systems consist of extruder, mould, downstream equipment, extrusion blow moulds. Extrusion systems for production of profiles consist of: extruder, profile mould, calibration, cooling zone, caterpillar take-off and roll take-off, separating device and tilting chute.

The present invention, accordingly, also relates to products, especially tracking-resistant products, obtainable by extrusion, preferably profile extrusion, or injection moulding of the moulding compounds obtainable from the compositions of the invention.

The present invention consequently also relates to halogen-free products, especially to leakage current-resistant, halogen-free products, obtainable by extrusion, preferably profile extrusion, or injection moulding of the moulding compounds obtainable from the compositions according to the invention.

It will be understood that the specification and examples are illustrative but not limitative of the present invention and that other embodiments within the spirit and scope of the invention will suggest themselves to those skilled in the art.

### EXAMPLES

In order to demonstrate the inventively described improvements in tracking resistance and mechanical properties, corresponding polyester moulding compounds were first of all prepared by compounding. The individual components were for this purpose mixed in a twin-screw extruder (ZSK 32 Mega Compounder from Coperion Werner & Pfleiderer (Stuttgart, Germany)) at temperatures in the range from 260 to 300° C., discharged as a strand, cooled until pelletizable and pelletized. After drying (generally 2 hours at 120° C. in a vacuum drying cabinet), the pellets were processed to form test specimens.

The test specimens for the investigations listed in Table 2 were moulded on an Arburg 320-210-500 injection moulding machine at a melt temperature of 260° C. and a mould temperature of 80° C.:

test rods 80 mm 10 mm·4 mm (as per ISO 178 or ISO180/1U)

ASTM-standard test specimens for UL94V testing

test specimens for glow wire testing to DIN EN 60695-2.13

test specimens for measurement of tracking resistance to IEC60112

The flexural strength and the outer fibre strain were obtained from flexural tests in accordance with ISO178 on test specimens with dimensions of 80 mm·10 mm·4 mm.

The impact resistance was obtained by the IZOD method in accordance with ISO180-1U on test specimens with dimensions of 80 mm·10 mm·4 mm.

The flame retardancy was determined by the UL94V method (Underwriters Laboratories Inc. Standard of Safety, “Test for Flammability of Plastic Materials for Parts in Devices and Appliances”, p. 14 to p. 18 Northbrook 1998). The dimensions of the test specimens were 125 mm·13 mm·0.75 mm.

The glow wire resistance was determined on the basis of the GMT (Glow Wire Ignition Temperature) test to DIN EN 60695-2-13. In the context of the GWIT test, the figure reported is the glow wire ignition temperature which is 25K (or 30K in the case of temperatures in the range from 900° C. to 960° C.) higher than the maximum glow wire temperature which fails to result in ignition in three successive tests, even during the time of exposure to the glow wire. Ignition here is taken to be a flame with a burn time ≧5 seconds. For the tests, circular plates with a diameter of 80 mm and a thickness of 0.75 mm were used. With regard to the objective underlying this invention, with the aim of no flammabiiity at all, i.e. a burn time of 0 seconds, in addition to the classification according to IEC 60695-2-13, the bum time at a glow wire temperature of 800° C. was also reported.

The comparative tracking index (or tracking resistance) was determined in accordance with IEC 60112 on test specimens with dimensions of 60 mm·40 mm·4 mm.

The melt viscosity was determined in the form of the melt volume-flow rate (MVR) in accordance with ISO1133-1 in each case at a temperature of 260° C. and 280° C. with an applied weight of 2.16 kg on the pellets in each case, the composition in each case being held for a residence time of 5 minutes for the purpose of assessing the temperature stability. Given comparable initial viscosity of the polymer used, the MVR is a measure of the degradation of the polymer as a result of thermal loading. A high figure for the MVR represents a low melt viscosity and hence a greater thermal degradation,

The following were used in the experiments:

Component A): Linear polybutylene terephthalate (Pecan® B 1300, commercial product of Lanxess Deutschland GmbH, Leverkusen, Germany) having an intrinsic viscosity of 93 cm³/g (measured in phenol: 1,2-dichlorobenzene=1:1 at 25° C.)

Component B): Aluminium tris(diethylphosphinate), [CAS No. 225789-38-8] (Exolit® OP1230 from Clariant SE, Muttenz, Switzerland)

Component C): Melamine cyanurate, (Melapur® MC25, from BASF SE, Ludwigshafen. Germany)

Component D): Zinc bis[dihydrogenphosphate] dihydrate [CAS No. 13986-21-5] (Z21-82 from Chemische Fabrik Buderiheim KG, Budenheim, Germany)

Component G): glass fibres having a diameter of 10 μm, sized with silane-containing compounds (CS 7987, commercial product from Lanxess N.V., Antwerp, Belgium)

Component F): Barium sulphate [CAS No.7727-43-7] (BLANC AXE Super F from Sachtleben Chemie GmbH, Duisburg, Germany)

Further component H) additives used in the examples were, as component H), the following components customary for use in flame-retardant thermoplastic polyesters:

Mould release agent: Pentaerythrityl tetrastearate (PETS) [CAS No. 115-83-3] (Loxiol® VPG 881, from Cognis Deutschland GmbH, Dusseldorf, Germany)

Heat stabilizer: Tetrakis(2,4-di-tert-butylphenyl)-1,1-biphenyl-4,4′-diyl bisphosphonite [CAS No. 38613-77-3] (Hostanox® P-EPQ from Clariant International Ltd., Muttenz, Switzerland)

Antidripping additive: Polytetrafluoroethylene, [CAS No. 9002-84-0] (Dyneon® PA 5932 from Dyneon GmbH & Co KG, Neuss, Germany)

The further additives used (component H)) match in nature and amount in each case for corresponding inventive and comparative examples, specifically with H)=0.7 wt %.

The sum of the fractions of the components adds up in each case to 100 wt %.

TABLE 1
(all amounts in wt %)

| | | | Comparative |
|---|---|---|---|
| | Example 1 | Example 2 | example |
| A) | 51 | 49.5 | 51.3 |
| B) | 16.5 | 16.5 | 16.5 |
| C) | 6.5 | 6.5 | 6.5 |
| D) | 0.3 | 0.3 | — |
| G) | 25 | 25 | 25 |
| F) | | 1.5 | |
| H) | 0.7 | 0.7 | 0.7 |

TABLE 2

| | | | | Comparative |
|---|---|---|---|---|
| | Unit | Example 1 | Example 2 | Example |
| IZOD | [kJ/m²] | 30 | 27 | 23 |
| Flexural strength | [MPa] | 145 | 141 | 135 |
| Outer fibre strain | [%] | 2.4 | 2.3 | 2 |
| Tracking resistance | [V] | 575 | 600 | 550 |
| MVR | [cm³/10 min] | 13.9 | 15 | 29.7 |
| 280° C./2.16 kg | | | | |
| MVR | [cm³/10 min] | 6.9 | 6.7 | 14.4 |
| 260° C./2.16 kg | | | | |
| GWIT | [° C.] | >775 | >775 | 775 |
| UL94 | [Class] | V-0 | V-0 | V-0 |

The examples show that when component D) is used, relative to the comparison without component D), an improvement can be achieved in the tracking resistance and in the mechanical properties. The improvement in the mechanical properties is evident both in the increased impact resistance and in the improvement in outer fibre strain and flexural strength. The improved mechanical properties can also be seen in connection with the much smaller MVR values relative to the comparative example without component C), which point to a lower level of polymer degradation. All improvements are unaccompanied by any negative effect on flame retardancy.

The test specimens for the studies listed in Table 3 were injection moulded in an Arburg 320-210-500 injection moulding machine at melt temperature 260° C. and mould temperature 80° C.:

test rods 80 mm·10 mm·4 mm (as per ISO 178 or ISO180/1U)

test specimens for glow wire testing to IEC 60695-2-13

Flexural strength was obtained from flexural tests in accordance with ISO178 on test specimens with dimensions of 80 mm·10 mm·4 mm.

Impact resistance was obtained by the IZOD method in accordance with ISO180-1U on test specimens with dimensions of 80 mm·10 mm·4 mm.

Table 3

Component A): linear polybutylene terephthalate (Pocan® B 1300, commercial product of Lanxess Deutschland GmbH, Leverkusen, Germany) having an intrinsic viscosity of 93 cm³/g (measured in phenol: 1,2-dichlorobenzene=1:1 at 25° C.)

Component B): aluminium tris(diethylphosphinate), [CAS No. 225789-38-8] (Exolit® OP1230 from Clariant SE, Muttenz, Switzerland)

Component C) melem [CAS No. 1502-47-2] having a melamine content of <1% (Delaval NFR from Delamin Ltd., Derby, UK)

Component D): magnesium bis(dihydrogenphosphate) [CAS No.13092-66-5]

Component E): melamine cyanurate, (Melapur® M25, from BASF SE, Ludwigshafen, Germany)

Component F): barium sulphate [CAS No. 7727-43-7] (BLANC FIXE Super F from Sachtleben Chemie GmbH, Duisburg, Germany)

Component G): glass fibres sized with silane-containing compounds and having a diameter of 10 μm (CS 7967, commercial product from Lanxess N.V., Antwerp, Belgium)

Further component H) additives used in the examples were, as component H/1), the following components customary for use in flame-retardant thermoplastic polyesters:

Demoulding agent: pentaerythrityl tetrastearate (PETS) [CAS No. 115-83-3] (Loxiol® VPG 861, from Cognis Deutschland GmbH, Düsseldorf, Germany)

Heat stabilizer: tetrakis(2,4-di-tert-butylphenyl)-1,1-biphenyl-4,4′-diyl bisphosphonite [CAS No. 38613-77-3] (Hostanox® P-EPQ from Clariant International Ltd., Muttenz, Switzerland)

Additive: polyietrafluoroethylene, [CAS No, 9002-84-0] (Dyneon® PA 5932 from Dyneon GmbH & Co KG, Neuss, Germany)

The further additives used (component H/1) correspond in each case in terms of nature and amount for corresponding inventive and comparative examples.

TABLE 3

| | | Ex. 3 | Comp. 1 | Comp. 2 |
|---|---|---|---|---|
| Component A/1 | [parts by | 100.0 | 100.0 | 100.0 |
| | mass] | | | |
| Component B/1 | [parts by | 31.3 | 31.0 | 27.5 |
| | mass] | | | |
| Component C/1 | [parts by | 12.9 | 12.8 | 0.0 |
| | mass] | | | |
| Component D/1 | [parts by | 0.6 | 0.0 | 0.0 |
| | mass] | | | |
| Component E/1 | [parts by | 12.9 | 12.8 | 11.4 |
| | mass] | | | |
| Component F/1 | [parts by | 2.6 | 2.6 | 2.3 |
| | mass] | | | |
| Component G/1 | [parts by | 53.9 | 53.5 | 47.4 |
| | mass] | | | |
| Component H/1 | [parts by | 1.3 | 1.3 | 1.1 |
| | mass] | | | |
| GWIT (IEC 60695-2- | [° C.] | ≧825 | ≧825 | <825 |
| 13) | | | | |
| IEC60695-2-13: | [s] | 0 | 0 | >5 |
| Burn time at 800° C. | | | | |
| MVR260/2, 16/5 | cm³/10 min | 10.5 | 19.8 | 23.2 |
| IZOD | [kJ/m²] | >20 | 14 | >20 |
| Flexural strength | [MPa] | >145 | 124 | >145 |

As a measure of the damage in the melt, the MVR measurements were conducted according to ISO 1133 with a Zwick/Roell B4106.200 flow test apparatus after a dwell time of 5 minutes. The testing after a dwell time of 5 minutes in the flow test apparatus allowed a comparative assessment of the degradation in the melt during the prior compounding in the twin-shaft extruder.

The MVR value in Ex. 3, determined according to ISO 1133 at 260° C. and with a weight of 2,16 kg, which is lower in spite of the same component A), compared to the higher MVR values of Comp. 1 and Comp. 2, is evidence of lower polymer degradation in the case of use of the inventive combination comprising component CM and component D/1. If at least one of the two components mentioned is absent, not only is the MVR value higher, but either the mechanical properties or the glow wire resistance is also inadequate with regard to the stated problem addressed by the invention.

What is claimed is:

1. A thermoplastic composition comprising;
A) at least one polyalkylene terephthalate or polycycloalkylene terephthalate;
B) at least one organic phosphinic salt of the formula (I) and/or at least one organic diphosphinic salt of the formula (II) and/or polymers thereof, 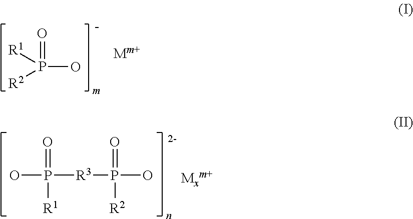
wherein
R¹, R² are the same or different and are each a linear or branched C₁-C₆-alkyl, and/or C₆-C₁₄-aryl,
R³ is linear or branched C₁-C₁₀ akylene, C₆-C₁₀ arylene or C₁-C₆ alkyl-C₆-C₁₀ arylene or C₆-C₁₀ aryl-C₁-C₆ alkylene,
M is aluminium, zinc or titanium,
m is an integer of 1 to 4;
n is an integer of 1 to 3, and
x is 1 or 2,
where n, x and m in formula (II), if present, may at the same time adopt only such integer values that the diphosphinic salt of the formula (II), as a whole, is uncharged;
C) at least one condensed melamine derivative;
D) at least one inorganic phosphate salt comprising aluminium tris(dihydrogenphosphate), magnesium bis(dihydrogenphosphate), zinc bis(dihydrogenphosphate), or zinc bis(dihydrogenphosphate) dihydrate, or mixtures thereof; and
E) at least one melamine derivative other than component C).

2. The composition according to claim 1, wherein the composition comprises, based on 100 parts by mass of component A):
10 to 70 parts by mass of component B),
1 to 30 parts by mass of component C),
0.01 to 5 parts by mass of component D), and
2 to 50 parts by mass of component E).

3. The composition according to claim 1, further comprising F) at least one metal sulphate.

4. The composition according to claim 2, further comprising F) at least one metal sulphate in an amount of 1 to 40 parts by mass, based on 100 parts by mass of component A).

5. The composition according to claim 1, further comprising G) at least one filler or reinforcer other than components B) to E).

6. The composition according to claim 2, further comprising G) at least one filler or reinforcer other than components B) to E) in an amount of 0.1 to 300 parts by mass, based on 100 parts by mass of component A).

7. The composition according to claim 1, further comprising H) at least one further additive other than components B) to E).

8. The composition according to claim 2, further comprising H) at least one further additive other than components B) to E) in an amount of 0.01 to 80 parts by mass, based on 100 parts by mass of component A).

9. The composition according to claim 2, further comprising:
F) at least one metal sulphate in an amount of 1 to 40 parts by mass, based on 100 parts by mass of component A);
at least one filler or reinforcer other than components B) to F) in an amount of 0.1 to 300 parts by mass, based on 100 parts by mass of component A); and
H) at least one further additive other than components B) to G) in an amount of 0.01 to 80 parts by mass, based on 100 parts by mass of component A).

10. The composition according to claim 1, wherein:
component C) comprises melam, melem, or melon, or mixtures thereof; and
component E) comprises melamine cyanurate, melamine polyphosphate, or melamine-intercalated aluminium salts, zinc sats or magnesium salts of condensed phosphates, or mixtures thereof.

11. The composition according to claim 10, wherein the composition comprises, based on 100 parts by mass of component A):
25 to 35 parts by mass of component B),
10 to 16 parts by mass of component C),
0.5 to 1 parts by mass of component D), and
10 to 20 parts by mass of component E).

12. The composition according to claim 1, wherein component C) comprises melem.

13. The composition according to claim 1, wherein the inorganic phosphate salt D) is in the form of a mixture with at least one of calcium pyrophosphate, calcium hydrogenphosphate, and calcium hydrogenphosphate dihydrate.

14. The composition according to claim 1, wherein A) is polybutylene terephthalate, B) is aluminium tris(diethylphosphinate), C) is melem, D) is magnesium bis(dihydrogenphosphate) and E) is melamine cyanurate.

15. The composition according to claim 1, wherein A) is polybutylene terephthalate, B) is aluminium tris(diethylphosphinate), C) is melem, D) is aluminium tris(dihydrogenphosphate) and E) is melamine cyanurate.

16. The composition according to claim 1, wherein A) is polybutylene terephthalate, B) is aluminium tris(diethylphosphinate), C) is melem, D) is zinc bis(dihydrogenphosphate) and E) is melamine cyanurate.

17. The composition according to claim 1, wherein A) is polybutylene terephthalate, B) is aluminium tris(diethylphosphinate), C) is melem, D) is zinc bis(dihydrogenphosphate) dihydrate and E) is melamine cyanurate.

18. A method for producing a polyester-based composition, the method comprising mixing at least one polyester A) with:
component B) at least one organic phosphinic salt of the formula (I) and/or at least one organic diphosphinic salt of the formula (II) and/or polymers thereof, 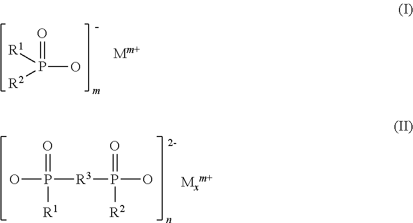
wherein
R¹, R² are the same or different and are each a linear or branched C₁-C₆-alkyl, and/or C₆-C ₁₄-aryl,
R³ is linear or branched C₁-C₁₀ alkylene, C₆-C₁₀ arylene or C₁-C₆-alkyl-C₆-C₁₀ arylene or C₅-C₁₀ aryl-C₁-C₆ alkylene,
M is aluminium, zinc or titanium,
m is an integer in the range from 1 to 4;
n is an integer in the range from 1 to 3, and
x is 1 or 2,
where n, x and m in formula (II) may at the same time adopt only such integer values that the diphosphinic salt of the formula (II) as a whole is uncharged,
component C), at least one condensed melamine derivative,
component D), at least one inorganic phosphate salt from the group of aluminium tris(dihydrogenphosphate), magnesium bis(dihydrogenphosphate), zinc bis(dihydrogenphosphate), and zinc bis(dihydrogenphosphate) dihydrate, and p1 component E) at least one melamine derivative other than component C) to form a mouldable composition.

19. method according to claim 18, wherein the polyester is selected from the group of the polyalkylene terephthalates and polycycloalkylene terephthalates, component C) is melem and component E) is melamine cyanurate.

20. The method according to claim 19, wherein the polyester-based composition is a moulded electrical or electronic assembly and/or components thereof, and the method further comprises:
mixing at least components A), B), C), D), and E) to give the moulding composition;
discharged the moulding composition in the form of an extrudate;
cooled the extrudate until pelletizable;
pelletizing the extrudate to for pellets; and
subjecting the pellets, as matrix material, to an injection moulding or extrusion operation; and
moulding or extruding the composition to form electrical or electronic assemblies and/or components thereof.
